(19) United States
(12) Patent Application Publication
(10) Pub. No.: US 2024/0281684 A1
(43) Pub. Date: Aug. 22, 2024

(54) METHOD AND SYSTEM FOR IDENTIFYING CAUSAL RECOURSE IN MACHINE LEARNING

(71) Applicant: JPMorgan Chase Bank, N.A., New York, NY (US)

(72) Inventors: Margarita BOYARSKAYA, New York, NY (US); Freddy LECUE, Mamaroneck, NY (US); Daniele MAGAZZENI, London (GB)

(73) Assignee: JPMorgan Chase Bank, N.A., New York, NY (US)

(21) Appl. No.: 18/112,797

(22) Filed: Feb. 22, 2023

(51) Int. Cl. G06N 5/045

(52) U.S. Cl. CPC G06N 5/045

(57) ABSTRACT

A method for identifying causal recourse for explanations of a plurality of models is disclosed. The method includes determining a causal model by using a corresponding causal graph and raw data, the causal graph relating to a description of relationships between covariates; selecting a list of model features from a model that explains a counterfactual outcome; computing causal counterfactual inputs by using the selected list and the determined causal model; generating predictions on causal counterfactuals by using the causal counterfactual inputs and the model; and verifying that the predictions correspond to the counterfactual outcome.

### BACKGROUND

### 1. Field of the Disclosure

This technology generally relates to methods and systems for providing recommended interventions, and more particularly to methods and systems for identifying causal recourse for explanations of machine learning models to compute causal explanations that follow the logic of the machine learning models and a predetermined causal structure.

### 2. Background Information

Many business entities rely on machine learning models to provide recommendations for recourse in various scenarios such as, for example, “what-if” scenarios. Often, conventional processes for identifying counterfactual explanations and feature attributions in machine learning present a set of features as explaining a counterfactual decision. Historically, implementations of these conventional processes have resulted in varying degrees of success with respect to providing true causal recourse such as, for example, recommending interventions that follow the logic of a corresponding machine learning model and causal structure.

One drawback of using these conventional processes is that in many instances, searching for the counterpart of a given input is typically performed in a way that ignores causal relationships between data variables. As a result, for a given machine learning model, merely applying counterfactual actions do not guarantee that the input data will be classified in the adverse class and a change in features is generally not guaranteed to result in a counterfactual outcome of a future prediction. Additionally, the search for a counterfactual counterpart may be interpreted as a directive for actionable change that will result in different decisions when predictions are made about persons and corresponding outcomes.

Therefore, there is a need to compute true causal recourse to provide recommended intervention/manipulation of data inputs that facilitates identification of counterfactuals with causal properties, while remaining constrained by a corresponding machine learning model.

### SUMMARY

The present disclosure, through one or more of its various aspects, embodiments, and/or specific features or sub-components, provides, inter alia, various systems, servers, devices, methods, media, programs, and platforms for identifying causal recourse for explanations of machine learning models to compute causal explanations that follow the logic of the machine learning models and a predetermined causal structure.

According to an aspect of the present disclosure, a method for identifying causal recourse for explanations of a plurality of models is disclosed. The method is implemented by at least one processor. The method may include determining at least one causal model by using a corresponding causal graph and raw data, the causal graph may relate to a description of at least one relationship between a plurality of covariates; selecting a list of a plurality of model features from at least one model that explains a counterfactual outcome; computing at least one causal counterfactual input by using the selected list and the determined at least one causal model; generating at least one prediction on causal counterfactuals by using the at least one causal counterfactual input and the at least one model; and verifying that the at least one prediction corresponds to the counterfactual outcome

In accordance with an exemplary embodiment, the method may further include computing a disagreement score for each of a plurality of causal outcomes, each of the plurality of causal outcomes may correspond to at least one data point; and aggregating the disagreement score from each of the plurality of causal outcomes to generate a combined score that represents all adversely affected data points.

In accordance with an exemplary embodiment, the method may further include determining at least one constraint based on the generated combined score, the at least one constraint may relate to a penalty that facilitates re-evaluation of feature attribution performance for each of the plurality of model features; and iteratively refining the selection of the list of the plurality of model features by incorporating the determined at least one constraint.

In accordance with an exemplary embodiment, the at least one causal model may correspond to a functional expression for joint distribution of all variables that factorize into a plurality of marginals, the at least one causal model may include a plurality of marginal probability equations that are determined by using the causal graph based on at least one parameter that is estimated from the raw data.

In accordance with an exemplary embodiment, to select the list of the plurality of model features, the method may further include computing, by using at least one type of machine learning algorithm, the plurality of models based on the raw data; identifying, for each of the plurality of models, at least one input data point from the raw data that is associated with the counterfactual outcome; determining, by using at least one predetermined feature attribution procedure, at least one model explanation for each of the at least one data point, the at least one model explanation may include the plurality of model features; and selecting, by using the at least one predetermined feature attribution procedure, the list of the plurality of model features from the at least one model according to at least one criterion.

In accordance with an exemplary embodiment, the at least one criterion may include at least one from among a predetermined stopping criterion and at least one determined constraint.

In accordance with an exemplary embodiment, to compute the at least one causal counterfactual input, the method may further include generating, by using the at least one causal model, a plurality of data points based on an output from the selected list of the plurality of model features.

In accordance with an exemplary embodiment, the output from the selected list of the plurality of model features may be used as potential interventions.

In accordance with an exemplary embodiment, the at least one model may include at least one from among a machine learning model, a mathematical model, a process model, and a data model.

According to an aspect of the present disclosure, a computing device configured to implement an execution of a method for identifying causal recourse for explanations of a plurality of models is disclosed. The computing device including a processor; a memory; and a communication interface coupled to each of the processor and the memory, wherein the processor may be configured to determine at least one causal model by using a corresponding causal graph and raw data, the causal graph may relate to a description of at least one relationship between a plurality of covariates; select a list of a plurality of model features from at least one model that explains a counterfactual outcome; compute at least one causal counterfactual input by using the selected list and the determined at least one causal model; generate at least one prediction on causal counterfactuals by using the at least one causal counterfactual input and the at least one model; and verify that the at least one prediction corresponds to the counterfactual outcome.

In accordance with an exemplary embodiment, the processor may be further configured to compute a disagreement score for each of a plurality of causal outcomes, each of the plurality of causal outcomes may correspond to at least one data point; and aggregate the disagreement score from each of the plurality of causal outcomes to generate a combined score that represents all adversely affected data points.

In accordance with an exemplary embodiment, the processor may be further configured to determine at least one constraint based on the generated combined score, the at least one constraint may relate to a penalty that facilitates re-evaluation of feature attribution performance for each of the plurality of model features; and iteratively refine the selection of the list of the plurality of model features by incorporating the determined at least one constraint.

In accordance with an exemplary embodiment, the at least one causal model may correspond to a functional expression for joint distribution of all variables that factorize into a plurality of marginals, the at least one causal model may include a plurality of marginal probability equations that are determined by using the causal graph based on at least one parameter that is estimated from the raw data.

In accordance with an exemplary embodiment, to select the list of the plurality of model features, the processor may be further configured to compute, by using at least one type of machine learning algorithm, the plurality of models based on the raw data; identify, for each of the plurality of models, at least one input data point from the raw data that is associated with the counterfactual outcome; determine, by using at least one predetermined feature attribution procedure, at least one model explanation for each of the at least one data point, the at least one model explanation may include the plurality of model features; and select, by using the at least one predetermined feature attribution procedure, the list of the plurality of model features from the at least one model according to at least one criterion.

In accordance with an exemplary embodiment, the at least one criterion may include at least one from among a predetermined stopping criterion and at least one determined constraint.

In accordance with an exemplary embodiment, to compute the at least one causal counterfactual input, the processor may be further configured to generate, by using the at least one causal model, a plurality of data points based on an output from the selected list of the plurality of model features.

In accordance with an exemplary embodiment, the processor may be further configured to use the output from the selected list of the plurality of model features as potential interventions.

In accordance with an exemplary embodiment, the at least one model may include at least one from among a machine learning model, a mathematical model, a process model, and a data model.

According to an aspect of the present disclosure, a non-transitory computer readable storage medium storing instructions for identifying causal recourse for explanations of a plurality of models is disclosed. The storage medium including executable code which, when executed by a processor, may cause the processor to determine at least one causal model by using a corresponding causal graph and raw data, the causal graph may relate to a description of at least one relationship between a plurality of covariates; select a list of a plurality of model features from at least one model that explains a counterfactual outcome; compute at least one causal counterfactual input by using the selected list and the determined at least one causal model; generate at least one prediction on causal counterfactuals by using the at least one causal counterfactual input and the at least one model; and verify that the at least one prediction corresponds to the counterfactual outcome.

In accordance with an exemplary embodiment, when executed by the processor, the executable code may further cause the processor to compute a disagreement score for each of a plurality of causal outcomes, each of the plurality of causal outcomes may correspond to at least one data point; aggregate the disagreement score from each of the plurality of causal outcomes to generate a combined score that represents all adversely affected data points; determine at least one constraint based on the generated combined score, the at least one constraint may relate to a penalty that facilitates re-evaluation of feature attribution performance for each of the plurality of model features; and iteratively refine the selection of the list of the plurality of model features by incorporating the determined at least one constraint.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for identifying causal recourse for explanations of machine learning models to compute causal explanations that follow the logic of the machine learning models and a predetermined causal structure.

FIG. 4 is a flowchart of an exemplary process for implementing a method for identifying causal recourse for explanations of machine learning models to compute causal explanations that follow the logic of the machine learning models and a predetermined causal structure.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

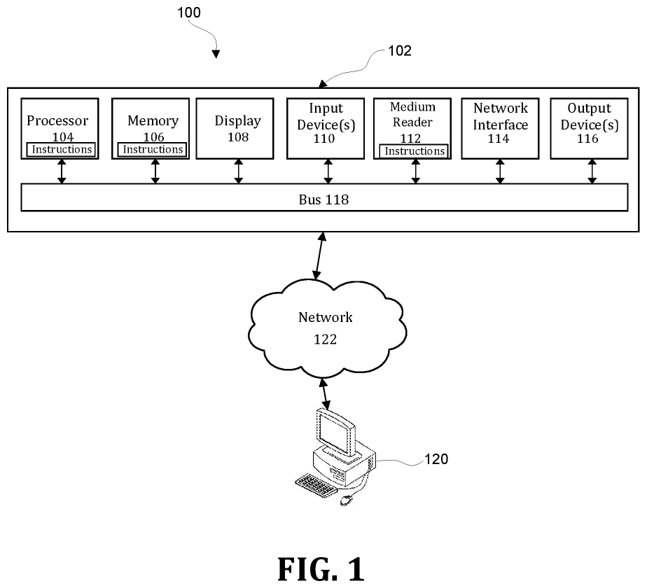

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for identifying causal recourse for explanations of machine learning models to compute causal explanations that follow the logic of the machine learning models and a predetermined causal structure.

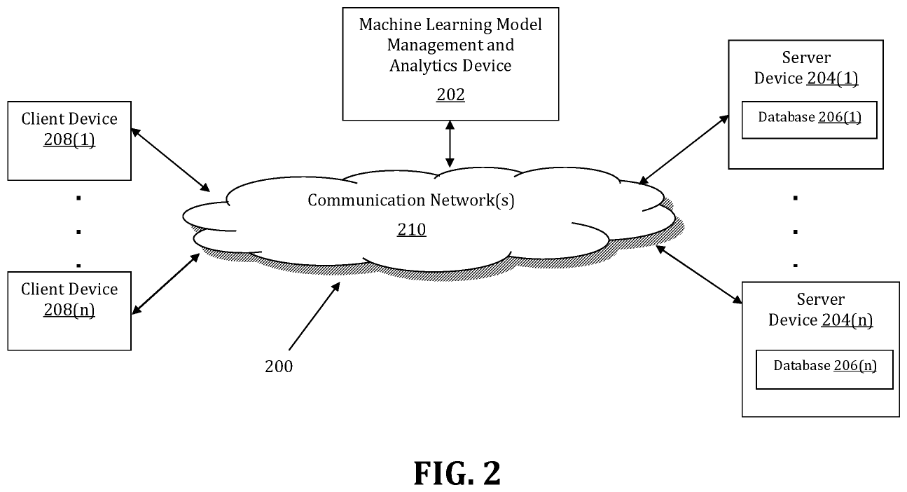

Referring to FIG. 2, a schematic of an exemplary network environment 200 for implementing a method for identifying causal recourse for explanations of machine learning models to compute causal explanations that follow the logic of the machine learning models and a predetermined causal structure is illustrated. In an exemplary embodiment, the method is executable on any networked computer platform, such as, for example, a personal computer (PC).

The method for identifying causal recourse for explanations of machine learning models to compute causal explanations that follow the logic of the machine learning models and a predetermined causal structure may be implemented by a Machine Learning Model Management and Analytics (MLMMA) device 202. The MLMMA device 202 may be the same or similar to the computer system 102 as described with respect to FIG. 1. The MLMMA device 202 may store one or more applications that can include executable instructions that, when executed by the MLMMA device 202, cause the MLMMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MLMMA device 202 itself, may be located in virtual server(s) running in a cloud-based computing environment rather than being tied to one or more specific physical network computing devices. Also, the application(s) may be running in one or more virtual machines (VMs) executing on the MLMMA device 202. Additionally, in one or more embodiments of this technology, virtual machine(s) running on the MLMMA device 202 may be managed or supervised by a hypervisor.

In the network environment 200 of FIG. 2, the MLMMA device 202 is coupled to a plurality of server devices 204(1)-204(n) that hosts a plurality of databases 206(1)-206(n), and also to a plurality of client devices 208(1)-208(n) via communication network(s) 210. A communication interface of the MLMMA device 202, such as the network interface 114 of the computer system 102 of FIG. 1, operatively couples and communicates between the MLMMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MLMMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and MLMMA devices that efficiently implement a method for identifying causal recourse for explanations of machine learning models to compute causal explanations that follow the logic of the machine learning models and a predetermined causal structure.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The MLMMA device 202 may be a standalone device or integrated with one or more other devices or apparatuses, such as one or more of the server devices 204(1)-204(n), for example. In one particular example, the MLMMA device 202 may include or be hosted by one of the server devices 204(1)-204(n), and other arrangements are also possible. Moreover, one or more of the devices of the MLMMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the MLMMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to causal recourse for model explanations, machine learning models, recommended interventions, causal models, causal graphs, raw data, covariates, model features, counterfactual outcomes, causal counterfactual inputs, predictions on causal counterfactuals, disagreement scores, disagreement penalties, and constraints.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the MLMMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the MLMMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the MLMMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the MLMMA device 202, the server devices 204(1)-204(n), or the client devices 208(1)-208(n), for example, may be configured to operate as virtual instances on the same physical machine. In other words, one or more of the MLMMA device 202, the server devices 204(1)-204(n), or the client devices 208(1)-208(n) may operate on the same physical device rather than as separate devices communicating through communication network(s) 210. Additionally, there may be more or fewer MLMMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

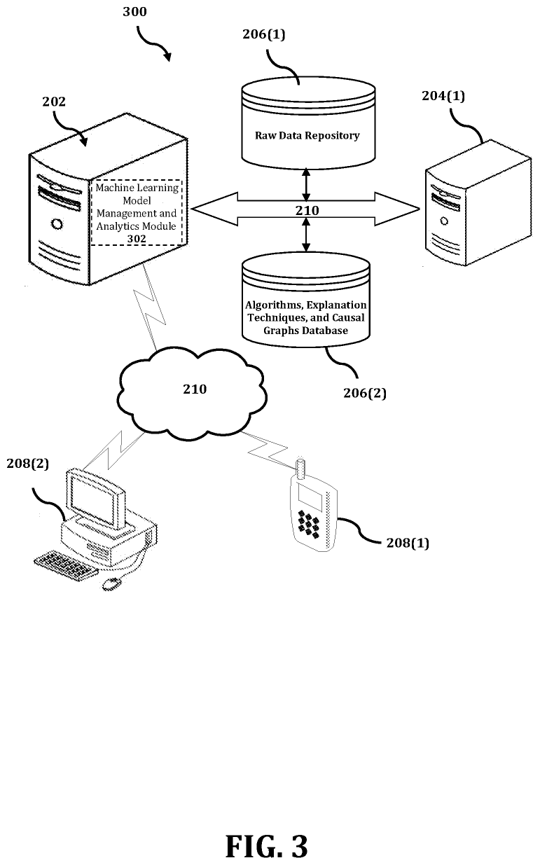

The MLMMA device 202 is described and shown in FIG. 3 as including a machine learning model management and analytics module 302, although it may include other rules, policies, modules, databases, or applications, for example. As will be described below, the machine learning model management and analytics module 302 is configured to implement a method for identifying causal recourse for explanations of machine learning models to compute causal explanations that follow the logic of the machine learning models and a predetermined causal structure.

An exemplary process 300 for implementing a mechanism for identifying causal recourse for explanations of machine learning models to compute causal explanations that follow the logic of the machine learning models and a predetermined causal structure by utilizing the network environment of FIG. 2 is shown as being executed in FIG. 3. Specifically, a first client device 208(1) and a second client device 208(2) are illustrated as being in communication with MLMMA device 202. In this regard, the first client device 208(1) and the second client device 208(2) may be “clients” of the MLMMA device 202 and are described herein as such. Nevertheless, it is to be known and understood that the first client device 208(1) and/or the second client device 208(2) need not necessarily be “clients” of the MLMMA device 202, or any entity described in association therewith herein. Any additional or alternative relationship may exist between either or both of the first client device 208(1) and the second client device 208(2) and the MLMMA device 202, or no relationship may exist.

Further, MLMMA device 202 is illustrated as being able to access a raw data repository 206(1) and an algorithms, explanation techniques, and causal graphs database 206(2). The machine learning model management and analytics module 302 may be configured to access these databases for implementing a method for identifying causal recourse for explanations of machine learning models to compute causal explanations that follow the logic of the machine learning models and a predetermined causal structure.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the MLMMA device 202 via broadband or cellular communication. Of course, these embodiments are merely exemplary and are not limiting or exhaustive.

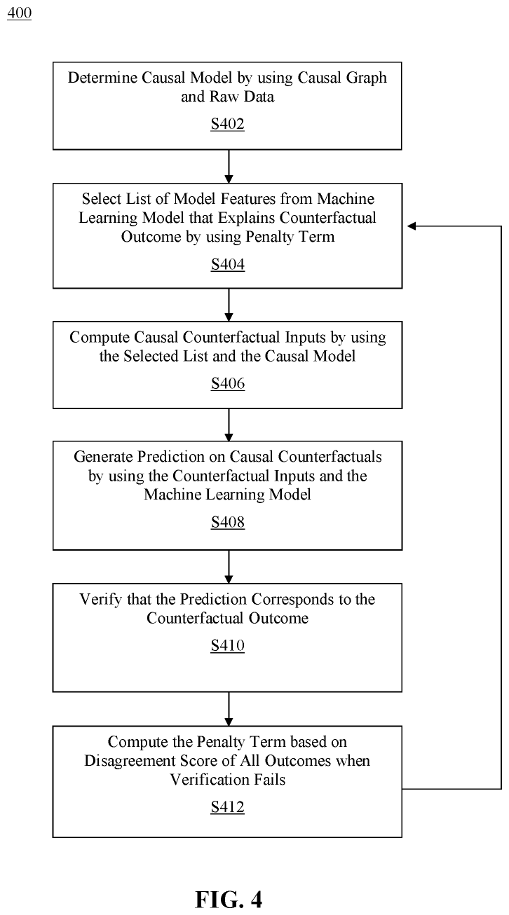

Upon being started, the machine learning model management and analytics module 302 executes a process for identifying causal recourse for explanations of machine learning models to compute causal explanations that follow the logic of the machine learning models and a predetermined causal structure. An exemplary process for identifying causal recourse for explanations of machine learning models to compute causal explanations that follow the logic of the machine learning models and a predetermined causal structure is generally indicated at flowchart 400 in FIG. 4.

In the process 400 of FIG. 4, at step S402, causal models may be determined by using a corresponding causal graph and raw data. In an exemplary embodiment, the causal models may correspond to a functional expression for joint distribution of all variables that factorize into a plurality of marginals. The causal models may include a plurality of marginal probability equations that are determined by using the causal graph based on at least one parameter that is estimated from the raw data. Consistent with present disclosures, the marginal distribution of a subset of a collection of random variables may correspond to the probability distribution of the variables contained in the subset. As such, the probabilities of various values of the variables in the subset may be provided without reference to the values of the other variables.

In another exemplary embodiment, the causal models may be estimated by using structural equation modeling (SEM) techniques. The SEM techniques may include at least one from among a linear regression technique, a Bayesian identification of structural coefficients in causal models technique, a maximum likelihood estimation technique, a Poisson directed acyclic graphical (DAG) modeling technique, a quadratic variance function (QVF) model technique, etc.

In another exemplary embodiment, the causal graph may relate to a description of relationships between a plurality of covariates. Domain knowledge may be used to describe causal relationships between the covariates. The domain knowledge may also be used to describe causal relationships between a subset of the covariates. Consistent with present disclosures, the covariates in a collection of data may correspond to independent variables that may influence the outcome of a given statistical analysis, but the independent variables themselves may not be of direct interest.

In another exemplary embodiment, the causal graph may be predetermined and provided as an input to facilitate estimation of the causal model. The input may be received from a source in an ad hoc manner as well as automatically retrieved from a repository to facilitate estimation of the causal model. For example, a causal graph that is associated with a raw data set may be automatically identified and retrieved to facilitate estimation of a causal model for the raw data set.

In another exemplary embodiment, the input may include the raw data, machine learning algorithms, the choice of hyperparameters, loss function and regularizers, as well as the choice of the evaluation metrics; the input may also include model explanation techniques and stopping criterions in addition to the causal graphs. Another input may include the choice of a similarity measure that will be used to constrain the choice of counterfactual examples “{x}” for a given input “x”. The raw data may correspond to a collection of information in any format such as, for example, a tabular data format, an image data format, and a textual data format. The raw data may include any combination of alphabetic characters, numeric characters, and symbolic characters.

Consistent with present disclosures, the machine learning algorithms may include decision tree algorithms, ensemble trees algorithms, neural network architectures algorithms, and linear regression algorithms as well as other algorithms that are usable to generate models in machine learning. Likewise, the model explanation techniques may correspond to any techniques for identifying feature attribution such as, for example, SHAPLEY additive explanations (SHAP) techniques, feature importance techniques, and counterfactual techniques. Furthermore, the stopping criterions may relate to a predetermined value such as, for example, a 5000 value that dictates a number of iterations in a machine learning process. The stopping criterion may be usable to save processing resources past a point of diminishing return and prevent continuous looping.

At step S404, a list of model features may be selected from a model that explains a counterfactual outcome. The list may correspond to a concise list of features that explain the decision for the counterfactual outcome. In an exemplary embodiment, the selection of the list of model features may include computing a plurality of models based on the raw data provided as input. The plurality of models may be computed, trained, and cross-validated by using at least one type of machine learning algorithm such as, for example, decision tree algorithms, ensemble trees algorithms, neural network architectures algorithms, and linear regression algorithms as well as other algorithms that are usable to generate models in machine learning.

Then, input data points from the raw data that is associated with the counterfactual outcome may be identified. The input data points may be identified for each of the plurality of models. For example, one or several explanations may be identified for a given input “x” and data points “x”, such that:

$$y ( {x}^{′} ) != r ( x ) .$$

Where “x” and “x′” are different from only a subset of its features—also described as actionable features for counterfactuals.

Moreover, additional constraints may usually be imposed to ensure that “x” is similar to “x” according to a chosen notion of similarity (e.g., close with respect to metric distance). Furthermore, the choice of “x′” examples may be such that that “x′” and “x” differ in actionable features, and not solely those that cannot be changed. In another exemplary embodiment, the choice of “x′” in relation to “x” may correspond to a change that is consistent with the laws of nature and chronology. In other words, for actionability/feasibility, the change from “x” to “x” must respect natural laws such as, for example, by not being anachronistic. For example, when component “i” of each datapoint represents age, then “xi” must be at least as large as “xi”. That is, the change from “x” to “x” cannot imply a reversal of time.

As a result, sets of explanations for an input point “x” for various models may be represented as:

$$CF \_set ( x , M 1 ) = \{ {x}^{′} \_ \{ 11 \} , x 1 \_ \{ 12 \} , {x}^{′} \{ 13 \} \}$$

$$CF \_set ( x , M 2 ) = \{ {x}^{′} \_ \{ 21 \} , x 1 \_ \{ 22 \} , {x}^{′} \{ 23 \} \}$$

$$CF \_set ( x , M 3 ) = \{ {x}^{′} \_ \{ 31 \} , x 1 \_ \{ 32 \} , {x}^{′} \{ 33 \} \}$$

$$CF \_set ( x , M 4 ) = \{ {x}^{′} \_ \{ 41 \} , x 1 \_ \{ 42 \} , {x}^{′} \{ 43 \} \} ,$$

Where M1, M2, M3, and M4 represents each of the plurality of models.

Further, model explanations may be determined for each of the data points. The model explanations may be determined by using at least one of the predetermined feature attribution procedures such as, for example, the model explanation techniques provided as input. The model explanations may include model features. Then, the listing of the model features from the model may be selected by using the predetermined feature attribution procedure according to at least one predetermined criterion. The at least one predetermined criterion may include at least one from among the predetermined stopping criterion from the input and determined constraints.

In another exemplary embodiment, the selection of the list may correspond to a machine learning process for the learning of the recourse for a counterfactual outcome. Using both data points for a given input, or simply just the data points, step S404 may offer a concise list of features that explain the decisions resulting in the counterfactual outcome. Additionally, step S404 may provide the concise list together with a recommended amount of change from an original input. As will be appreciated by a person of ordinary skill in the art, to achieve the desired outcomes, a learning approach to feature attribution such as, for example, robust attribution regularization must be followed.

For example, using “(x, x′)”, or just “(x′)”, a concise list of features that explains the decision “y(x′)” may be offered. Consistent with present disclosures, the concise list of features may be offered together with the recommended amount of change from the original “x” such that:

$$XAI ( x , {x}^{′} \_ \{ 11 \} ) = ( {A}^{′} = A - 1 , {B}^{′} = B + 3 , {C}^{′} = C - 2 , … ) ,$$

$$XAI ( x , {x}^{′} \_ \{ 12 \} ) = ( {A}^{′} = A - 4 , {C}^{′} = C + 2 , … ) , …$$

In another exemplary embodiment, learning the recourse for a counterfactual outcome y(x′) may be further refined consistent with present disclosures. Refinement may be required based on a result of an evaluation such as, for example, a failed validation of a predictive output. For example, the process for feature attribution performance may be further refined in an iterative manner by using aggregated disagreement scores that represent all adversely affected data points. The feature attribution performance may be re-evaluated by using the aggregated disagreement scores as a penalty. In another exemplary embodiment, the refinement may be constrained by a predetermined criterion such as, for example, a stopping criterion that governs a maximum number of iterations.

In another exemplary embodiment, the model features may each correspond to an individual measurable property and/or characteristic of a phenomenon. In machine learning and pattern recognition, the model features may relate to individual independent variables that act similar to inputs in a system and may dictate outcomes. In another exemplary embodiment, the counterfactual outcome may correspond to a counterfactual explanation that describes a causal situation in the form of a “what-if” statement such as, for example, when X had not occurred, Y would not have occurred. The counterfactual explanation may require imagining a hypothetical reality that contradicts observed facts. In machine learning, counterfactual explanations may be used to explain predictions of individual instances.

In another exemplary embodiment, the model may include at least one from among a machine learning model, a mathematical model, a process model, and a data model. The model may relate to machine learning algorithms such as, for example, decision tree algorithms, ensemble trees algorithms, neural network architectures algorithms, and linear regression algorithms. Using various machine learning algorithms may result in various corresponding model architectures. For example, a tree-based machine learning model architecture may be computed by using a decision tree algorithm.

In another exemplary embodiment, the model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S406, causal counterfactual inputs may be computed by using the selected list and the determined causal models. In an exemplary embodiment, computing the causal counterfactual inputs may include generating a plurality of data points based on an output from the selected list of the plurality of model features. The output from the selected list of the plurality of model features may be usable as potential interventions and the plurality of data points may be generated by using the causal model. Further, the plurality of data points may correspond to a true counterfactual such that each of the plurality of data points reflect causal relationships between input data variables, while remaining constrained by the model. Consistent with present disclosures, the causal counterfactual inputs may include the plurality of data points.

For example, output of “XAI” may be usable as suggested interventions, i.e., the potential interventions. Likewise, the causal model may be usable to generate, likely unobserved, data points that correspond to the true, natural counterfactuals such that:

$${x}^{⋀} \_ \{ 11 \} = G \_do ( XAI ( x , {x}^{′} \_ \{ 11 \} ) ,$$

$${x}^{⋀} \_ \{ 12 \} = G \_do ( XAI ( x , {x}^{′} \_ \{ 12 \} ) , …$$

At step S408, predictions on causal counterfactuals may be generated by using the causal counterfactual inputs and the model. In an exemplary embodiment, the predictions may use the computed causal counterfactual inputs as model inputs for the corresponding model. Consistent with present disclosures, the model may output a prediction on causal counterfactuals based on the computed causal counterfactual inputs. The causal counterfactuals may correspond to counterfactuals that reflect the causal relationships between data variables in the initial input data. Then, at step S410, whether the predictions correspond to the counterfactual outcome may be verified. Consistent with present disclosures, the counterfactual outcome may have been previously identified for the model together with one or several model explanations.

For example, computing predictions on causal counterfactuals and verifying whether the predictions on causally counterfactual inputs correspond to counterfactual outcomes may be represented as:

$${x}^{′} \_ \{ 11 \} was chosen because M 1 ( {x}^{′} \_ 11 ) ! = M 1 ( x ) ,$$

$${x}^{′} \_ \{ 11 \} suggested an intervention XAI ( x , {x}^{′} \_ \{ 11 \} ) ,$$

$${x}^{⋀} \_ \{ 11 \} is the result of performing such an intervention casually .$$

For recommended recourse to be valid in the causal sense, it must be true that:

$$M 1 ( {x}^{⋀} \_ \{ 11 \} ) ! = M 1 ( x ) .$$

At step S412, disagreements between counterfactuals may be introduced as a constraint to optimization. To facilitate the introduction, a disagreement score may be computed for each of the causal outcomes. The causal outcomes may correspond to data points in an adversely classified example. The disagreement scores may be computed for all outcomes that have been computed causally. Then, the disagreement scores may be aggregated from each of the causal outcomes into a single score for all adversely affected data points. In another exemplary embodiment, a combined score may be generated from the aggregated disagreement scores. The combined score may correspond to the single score that represents all adversely affected data points.

In another exemplary embodiment, causality may be incorporated into evaluation of feature attribution performance to verify whether outcome labels would be flipped. For example, when plugging the causal counterfactual input into a model results in a flipped outcome, an agreement is realized between causally unaware and causally aware outcomes (i.e., outcomes that result from suggested changes in key features). However, when there is disagreement, the original counterfactuals may not be trusted, and a penalty must be incorporated to facilitate re-evaluation of the feature attribution performance. In other words, the penalty will be incurred when there is a disagreement such that the penalty will lead the algorithm to re-evaluate the selection of key model features until the disagreement is minimized. In another exemplary embodiment, constraints may be determined based on the generated combined score. The constraints may relate to the penalty that facilitates re-evaluation of feature attribution performance for each of the model features.

Then, consistent with present disclosures, the selection of the list of model features may be refined by incorporating the determined constraints. The refinement may relate to an iterative process that further refines the computation of counterfactuals in S406 when validation fails at S410. For example, when validation of the prediction fails, feature attribution performance related to the selected list of model features may be re-evaluated by using the determined constraints. The refinement process may be repeated until validation occurs or until satisfaction of a predetermined criterion such as, for example, a stopping criterion that governs a number of iterations.

In another exemplary embodiment, the causal explanations may relate to realistic and actionable explanations of models learnt from data and validated by causal structures. The causal explanations may rely on the causal relationships between data variables while remaining constrained by the model.

Accordingly, with this technology, an optimized process for identifying causal recourse for explanations of machine learning models to compute causal explanations that follow the logic of the machine learning models and a predetermined causal structure is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying causal recourse for explanations of a plurality of models, the method being implemented by at least one processor, the method comprising:
determining, by the at least one processor, at least one causal model by using a corresponding causal graph and raw data, the causal graph relating to a description of at least one relationship between a plurality of covariates;
selecting, by the at least one processor, a list of a plurality of model features from at least one model that explains a counterfactual outcome;
computing, by the at least one processor, at least one causal counterfactual input by using the selected list and the determined at least one causal model;
generating, by the at least one processor, at least one prediction on causal counterfactuals by using the at least one causal counterfactual input and the at least one model; and
verifying, by the at least one processor, that the at least one prediction corresponds to the counterfactual outcome.

2. The method of claim 1, further comprising:
computing, by the at least one processor, a disagreement score for each of a plurality of causal outcomes, each of the plurality of causal outcomes corresponding to at least one data point; and
aggregating, by the at least one processor, the disagreement score from each of the plurality of causal outcomes to generate a combined score that represents all adversely affected data points.

3. The method of claim 2, further comprising:
determining, by the at least one processor, at least one constraint based on the generated combined score, the at least one constraint relating to a penalty that facilitates re-evaluation of feature attribution performance for each of the plurality of model features; and
iteratively refining, by the at least one processor, the selection of the list of the plurality of model features by incorporating the determined at least one constraint.

4. The method of claim 1, wherein the at least one causal model corresponds to a functional expression for joint distribution of all variables that factorize into a plurality of marginals, the at least one causal model including a plurality of marginal probability equations that are determined by using the causal graph based on at least one parameter that is estimated from the raw data.

5. The method of claim 1, wherein selecting the list of the plurality of model features further comprises:
computing, by the at least one processor using at least one type of machine learning algorithm, the plurality of models based on the raw data;
identifying, by the at least one processor for each of the plurality of models, at least one input data point from the raw data that is associated with the counterfactual outcome;
determining, by the at least one processor using at least one predetermined feature attribution procedure, at least one model explanation for each of the at least one data point, the at least one model explanation including the plurality of model features; and
selecting, by the at least one processor using the at least one predetermined feature attribution procedure, the list of the plurality of model features from the at least one model according to at least one criterion.

6. The method of claim 5, wherein the at least one criterion includes at least one from among a predetermined stopping criterion and at least one determined constraint.

7. The method of claim 1, wherein computing the at least one causal counterfactual input further comprises:
generating, by the at least one processor using the at least one causal model, a plurality of data points based on an output from the selected list of the plurality of model features.

8. The method of claim 7, wherein the output from the selected list of the plurality of model features is used as potential interventions.

9. The method of claim 1, wherein the at least one model includes at least one from among a machine learning model, a mathematical model, a process model, and a data model.

10. A computing device configured to implement an execution of a method for identifying causal recourse for explanations of a plurality of models, the computing device comprising:
a processor;
a memory; and
a communication interface coupled to each of the processor and the memory,
wherein the processor is configured to:
determine at least one causal model by using a corresponding causal graph and raw data, the causal graph relating to a description of at least one relationship between a plurality of covariates;
select a list of a plurality of model features from at least one model that explains a counterfactual outcome;
compute at least one causal counterfactual input by using the selected list and the determined at least one causal model;
generate at least one prediction on causal counterfactuals by using the at least one causal counterfactual input and the at least one model; and
verify that the at least one prediction corresponds to the counterfactual outcome.

11. The computing device of claim 10, wherein the processor is further configured to:
compute a disagreement score for each of a plurality of causal outcomes, each of the plurality of causal outcomes corresponding to at least one data point; and
aggregate the disagreement score from each of the plurality of causal outcomes to generate a combined score that represents all adversely affected data points.

12. The computing device of claim 11, wherein the processor is further configured to:
determine at least one constraint based on the generated combined score, the at least one constraint relating to a penalty that facilitates re-evaluation of feature attribution performance for each of the plurality of model features; and
iteratively refine the selection of the list of the plurality of model features by incorporating the determined at least one constraint.

13. The computing device of claim 10, wherein the at least one causal model corresponds to a functional expression for joint distribution of all variables that factorize into a plurality of marginals, the at least one causal model including a plurality of marginal probability equations that are determined by using the causal graph based on at least one parameter that is estimated from the raw data.

14. The computing device of claim 10, wherein, to select the list of the plurality of model features, the processor is further configured to:
compute, by using at least one type of machine learning algorithm, the plurality of models based on the raw data;
identify, for each of the plurality of models, at least one input data point from the raw data that is associated with the counterfactual outcome;
determine, by using at least one predetermined feature attribution procedure, at least one model explanation for each of the at least one data point, the at least one model explanation including the plurality of model features; and
select, by using the at least one predetermined feature attribution procedure, the list of the plurality of model features from the at least one model according to at least one criterion.

15. The computing device of claim 14, wherein the at least one criterion includes at least one from among a predetermined stopping criterion and at least one determined constraint.

16. The computing device of claim 10, wherein, to compute the at least one causal counterfactual input, the processor is further configured to:
generate, by using the at least one causal model, a plurality of data points based on an output from the selected list of the plurality of model features.

17. The computing device of claim 16, wherein the processor is further configured to use the output from the selected list of the plurality of model features as potential interventions.

18. The computing device of claim 10, wherein the at least one model includes at least one from among a machine learning model, a mathematical model, a process model, and a data model.

19. A non-transitory computer readable storage medium storing instructions for identifying causal recourse for explanations of a plurality of models, the storage medium comprising executable code which, when executed by a processor, causes the processor to:
determine at least one causal model by using a corresponding causal graph and raw data, the causal graph relating to a description of at least one relationship between a plurality of covariates;
select a list of a plurality of model features from at least one model that explains a counterfactual outcome;
compute at least one causal counterfactual input by using the selected list and the determined at least one causal model;
generate at least one prediction on causal counterfactuals by using the at least one causal counterfactual input and the at least one model; and
verify that the at least one prediction corresponds to the counterfactual outcome.

20. The storage medium of claim 19, wherein, when executed by the processor, the executable code further causes the processor to:
compute a disagreement score for each of a plurality of causal outcomes, each of the plurality of causal outcomes corresponding to at least one data point;
aggregate the disagreement score from each of the plurality of causal outcomes to generate a combined score that represents all adversely affected data points;
determine at least one constraint based on the generated combined score, the at least one constraint relating to a penalty that facilitates re-evaluation of feature attribution performance for each of the plurality of model features; and
iteratively refine the selection of the list of the plurality of model features by incorporating the determined at least one constraint.
